(19) United States
(12) Patent Application Publication
(10) Pub. No.: US 2009/0208739 A1
(43) Pub. Date: Aug. 20, 2009

(54) ADHESIVE FILM WITH HIGH OPTICAL TRANSPERANCY, AS AN ANTI-SPLINTER COVER FOR ADHERING TO GLASS WINDOWS IN ELECTRONIC COMPONENTS FOR CONSUMER ITEMS

(75) Inventors: Marc Husemann, Hamburg (DE); Reinhard Storbeck, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 12/375,416

(22) PCT Filed: Jun. 29, 2007
(86) PCT No.: PCT/EP07/56536

§ 371 Date: May 7, 2009

(30) Foreign Application Priority Data
Jul. 28, 2006 (DE) 102006035786.8

(51) Int. Cl. C09J 7/02; B32B 7/12; C09J 133/08; C09J 119/00; B32B 37/12; C09J 133/10

(52) U.S. Cl. 428/354; 428/343; 428/355 AC; 428/355 R; 156/60

(57) ABSTRACT

The invention relates to an adhesive film comprising at least one carrier film and at least one layer of an adhesive material. The invention is characterised in that the carrier film has a tensile strength of at least 50 MPa, measured according to ASTM D882, a haze value of no more than 3%, measured according to ASTM D1003, and a transmission of at least 80%, measured according to ASTM D1003, in light with a wavelength of 550 nm; and in that the adhesive film has a transmission of at least 70%, measured according to ASTM D1003. The invention also relates to the use of a corresponding single-sided or double-sided adhesive film, as an anti-splinter cover for glass windows, especially for electronic consumer items.

The invention relates to single-sided or double-sided pressure-sensitive adhesive films for use in the bonding of glass windows in consumer electronics items. In the case of improper use or in the event of vigorous impacts, the adhesive tape is intended to prevent the splintering of the glass window in the electronic device.

For electronic goods in the display area it is very common to use plastic windows. A known example are PDAs (Personal Digital Assistants; pocket computers), for example. In the watch industry as well, however, plastic windows are often used as glasses. The plastics systems have a number of advantages. For example, they are inexpensive, lightweight, not prone to fracture, and easy to process. However, these plastic windows are not without their disadvantages. For example, in everyday use they are not scratch-resistant, and also have only moderate brightness as a result of the limited refractive index.

Increasingly, therefore, glass windows are being trialed as viewing windows in consumer electronics items. Apart from the higher transparency and brightness as a result of the higher refractive index, however, there continues to be the risk of fracture.

One possible solution lies in a three-layer glass. Here, in analogy to windshields in the automobile sector, a PVB film (polyvinyl butyral film) is introduced between two glass sheets and hence an anti-splinter device is produced. For reasons of cost, however, this solution is not available for mass media. Accordingly there continues to be a need for a solution in the consumer electronics sector.

It is an object of the invention, therefore, to offer an anti-splinter device for glass windows, especially for the consumer electronics industry, while avoiding the disadvantages of the prior art.

The object is achieved, surprisingly and unforeseeably, by a highly transparent, single-sided or double-sided pressure-sensitive adhesive film having high adhesive properties on glass, as is set out in the main claim.

In the event of the glass fracturing, the single-sided or double-sided pressure-sensitive adhesive film functions as an anti-splinter device, and the glass splinters remain adhering to the pressure-sensitive adhesive film. The single-sided or double-sided pressure-sensitive adhesive film is to be highly transparent and hence is not to negatively influence the optical properties of the glass window.

In the context of this specification the designations (pressure-sensitive) adhesive film and (pressure-sensitive) adhesive tape are used synonymously.

In the design and configuration of optical components, such as glass windows, for example, it is necessary to take account of the interaction of the materials used with the nature of the irradiated light. In one derived version the law of energy conservation takes on the form

T(λ)+p(λ)+a(λ)=1

where T(λ) describes the fraction of transmitted light, p(λ) the fraction of reflected light, and a(λ) the fraction of absorbed light (X: wavelength), and where the overall intensity of the irradiated light is standardized to 1. Depending on the application of the optical component, the task is to optimize individual ones of these three terms and to suppress the others. Optical components which are designed for transmission are to feature values for T(λ) that are close to 1. This is achieved by reducing the amount of p(λ) and a(λ). Pressure-sensitive adhesives based on acrylate copolymer and acrylate block copolymer normally have no significant absorption in the visible range, i.e., in the wavelength range between 400 nm and 700 nm. This can easily be checked by measurements with a UV-Vis spectralphotometer. Of critical interest, therefore, is p(λ). Reflection is an interfacial phenomenon, which is dependent on the refractive indices n_{d,i} of two phases i that enter into contact with one another, in accordance with the Fresnel equation

$$ρ ( λ ) = {( \frac{{n}_{d , 2} - {n}_{d , 1}}{{n}_{d , 2} + {n}_{d , 1}} )}^{2} .$$

For the case of isorefractive materials, for which n_{d,2}=n_{d,1,} p(λ) becomes 0. This explains the need to adapt the refractive index of a pressure-sensitive adhesive that is to be used for optical components to the refractive indices of the materials to be bonded. Typical values for a variety of such materials are set out in table 1.

TABLE 1

| Material | Refractive index n_{d} |
|---|---|
| Quartz glass | 1.458 |
| Borosilicate Crown (BK7) | 1.514 |
| Borosilicate Crown | 1.518 |
| Flint | 1.620 |

(Source: Pedrotti, Pedrotti, Bausch, Schmidt, Optik, 1996, Prentice-Hall, Munich. Data for X = 588 nm)

In the context of this invention the specific application relates to the bonding of a single-sided or double-sided pressure-sensitive adhesive film over the full area of a glass window for use as an anti-splinter device in electronic components for consumer items. Single-sided pressure-sensitive adhesive tapes offer only anti-splinter protection in this context. Double-sided pressure-sensitive adhesive tapes, in contrast, possess the further advantage that, in addition to the anti-splinter protection, the pressure-sensitive adhesive tape can also be utilized for fixing.

For the attachment of pressure-sensitive adhesive films of this kind the requirements imposed are high. For instance, the adhesive ought to be highly transparent, so as not substantially to reduce the transparency of the glass window. This can be achieved, in accordance with the earlier remarks, by minimizing the fractions of absorbed and reflected light. It is therefore necessary to adapt the refractive index of the pressure-sensitive adhesive and also of the carrier to that of the glass window.

As a result of their inherent tack, the pressure-sensitive adhesives must possess a relatively low glass transition temperature. This limits the aromatic fraction (high quantities of aromatics lower the glass transition temperature), and so a maximum refractive index cannot be achieved via high fractions of aromatics in the pressure-sensitive adhesive.

### Pressure-Sensitive Adhesive (PSA)

The PSA coatweight in accordance with the invention is, advantageously, for single-sided PSA tapes, between 10 and 150 g/m², more preferably between 20 and 100 g/m². The PSA coatweight is, in accordance with the invention, for double-sided PSA tapes, advantageously between 5 and 100 g/m², more preferably between 10 and 75 g/m², per side.

Examples of types of PSA which attain very high refractive indices include silicone rubbers. These are described for example in U.S. Pat. No. 4,874,671.

In a further case it is possible to use acrylate block copolymers as PSAs.

In the case of the acrylate block copolymers there are a large number of monomers that can be utilized for the synthesis of a PSA possessing high refractive index, and so a broad range of PSA properties can be set through the chemical make-up; furthermore, the advantage is obtained that highly cohesive layers of PSA can be produced without additional crosslinking steps in the operation.

The acrylate block copolymer advantageously has at least the unit P(A)-P(B)-P(A) comprising at least one polymer block P(B) and at least two polymer blocks P(A), where
P(A) represent, independently of one another, homopolymer or copolymer blocks comprising at least 75% by weight of monomers of group A, the (co)polymer blocks P(A) each having a softening temperature in the range from 0° C. to +175° C.,
P(B) represents a homopolymer or copolymer block comprising monomers of group B, the (co)polymer block P(B) having a softening temperature in the range from −130° C. to +10° C.,
the (co)polymer blocks P(A) and P(B) are not homogeneously miscible with one another at 25° C.,
   characterized in that
the PSA has a refractive index n_{d,H} of n_{d,H}>1.52 at 20° C.,
at least one of the (co)polymer blocks P(A) has a refractive index n_{d,A} of n_{d,A}>1.58 at 20° C.,
the (co)polymer block P(B) has a refractive index n_{d,B} of n_{d,B}>1.43 at 20° C.

For the invention it may be of particular advantage if all the (co)polymer blocks P(A) each have a refractive index n_{d,A} of n_{d,A}>1.58 at 20° C.

For the purposes of the invention it is additionally of advantage if the block copolymer or copolymers are present in the PSA at 50% by weight at least.

The refractive index n_{d} is defined according to Snell's law of refraction and depends on the wavelength of the irradiated light and on the temperature. For the purposes of this text it is understood to be the value which is measured at T=25° C. with white light (λ=550 nm±150 nm).

In the further text the polymer blocks P(A) are also referred to as hard blocks and the polymer blocks P(B) as elastomer blocks.

By softening temperature is meant the glass transition temperature in the case of amorphous systems and the melting temperature in the case of semicrystalline systems. Glass temperatures are reported as results from quasi-steady-state methods such as differential scanning calometry (DSC), for example.

PSAs which have proven particularly advantageous in the sense of the invention are those which possess a refractive index n_{d} of greater than 1.52 and for which the structure of the block copolymer/block copolymers can be described by one or more of the following general formulae:

P(A)-P(B)-P(A) (I)

P(B)-P(A)-P(B)-P(A)-P(B) (II)

[P(A)-P(B)]ₙX (III)

[P(A)-P(B)]ₙX[P(A)]ₘ (IV),

where n=3 to 12, m=3 to 12 and X is a polyfunctional branching unit, i.e., a chemical structural element via which different polymer arms are linked to one another, where, further, the polymer blocks P(A) independently of one another represent homopolymer or copolymer blocks comprising at least 75% by weight of monomers of group A, the polymer blocks P(A) each having a softening temperature in the range from 0° C. to +175° C. and possessing a refractive index n_{d,A} of greater than 1.58, and where the polymer blocks P(B) independently of one another represent homopolymer or copolymer blocks comprising monomers of group B, the polymer blocks P(B) each having a softening temperature in the range from −130° C. to +10° C. and possessing a refractive index n_{d,B} of greater than 1.43.

The polymer blocks P(A) as described in the main claim or in the advantageous embodiments can be polymer chains of a single variety of monomer from group A or can be copolymers of monomers of different structures from group A; where appropriate they can be copolymers of at least 75% by weight of monomers of group A and up to 25% by weight of monomers of group B. The monomers used from group A may vary in particular in their chemical structure and/or in the side chain length. The polymer blocks therefore cover the range between fully homogeneous polymers, via polymers formed from monomers of the same chemical parent structure but differing in chain length, and polymers with the same number of carbons but differing in isomerism, through to randomly polymerized blocks of monomers of different length with different isomerism from group A. The same is true of the polymer blocks P(B) in respect of the monomers from group B.

For the purposes of this text the term “polymer blocks” is therefore intended to include not only homopolymer blocks but also copolymer blocks, unless specified otherwise in a specific case.

The unit P(A)-P(B)-P(A) may be either symmetrical [corresponding to P¹(A)-P(B)-P²(A) where P¹(A)=P²(A)] or asymmetrical [corresponding for instance to the formula P³(A)-P(B)-P⁴(A) where P³(A)≠P⁴(A), but where both P³(A) and P⁴(A) are each polymer blocks as defined for P(A)] in construction.

An advantageous configuration is one in which the block copolymers have a symmetrical construction such that polymer blocks P(A) identical in chain length and/or chemical structure are present and/or such that polymer blocks P(B) identical in chain length and/or chemical structure are present.

P³(A) and P⁴(A) may differ in particular in their chemical composition and/or their chain length.

Starting monomers of group A for the polymer blocks P(A) are preferably selected such that the resulting polymer blocks P(A) are immiscible with the polymer blocks P(B) and, accordingly, microphase separation occurs.

Block copolymers may have characteristics which, in terms of the compatibility of the blocks with one another, are similar to those of polymers which are present independently. On the basis of the incompatibility which generally exists between different polymers, these polymers, after having been mixed beforehand, separate out again. More or less homogeneous regions made up of the individual polymers are formed. In the case of block copolymers (e.g., diblock, triblock, star block, multiblock copolymers), this incompatibility may also exist between the individual, different polymer blocks. Here it is then possible for the separation to occur only to a limited extent, however, since the blocks are connected to one another chemically. So-called domains (phases) are formed, in which two or more blocks of the same kind congregate. Since the domains are within the same order of magnitude as the original polymer blocks, the term “microphase separation” is used.

The polymer blocks may in particular form elongated, microphase-separated regions (domains), in the form for example of prolate, i.e., uniaxially elongated (e.g., rodlet-shaped), structural elements; oblate, i.e., biaxially elongated (e.g., layer-shaped), structural elements; three-dimensionally cocontinuous microphase-separated regions; or a continuous matrix of one kind of polymer block (typically that with the higher weight fraction) with regions of the other kind of polymer block (typically that with the lower weight fraction) dispersed therein.

Advantageously the typical domain sizes are smaller than 400 nm, more preferably smaller than 200 nm.

Suitable monomers of group A contain a C═C double bond, in particular one or more vinyl groups in the true sense and/or vinylic groups. Vinylic groups referred to here are groups wherein some or all of the hydrogen atoms of the unsaturated carbon atoms have been substituted by organic and/or inorganic radicals. In this sense, acrylic acid, methacrylic acid and/or derivatives thereof are also included among the compounds containing vinylic groups. The above compounds are referred to collectively below as vinyl compounds.

Advantageous examples of compounds which can be used as monomers of group A are vinylaromatics which as polymers possess a refractive index of greater than 1.58 at 25° C. Specific monomers, whose recitation is only by way of example, however, include styrene, α-methylstyrene, o-methylstyrene, o-methoxystyrene, p-methoxystyrene or 4-methoxy-2-methylstyrene, for example.

As monomers of group A it is further possible with advantage to use acrylates, such as acrylate-terminated polystyrene or α-bromophenyl acrylate, for example, and/or methacrylates, such as methacrylate-terminated polystyrene (for example, Methacromer PS 12 from Polymer Chemistry Innovations), 1,2-diphenylethyl methacrylate, diphenylmethyl methacrylate, o-chlorobenzyl methacrylate or p-bromophenyl methacrylate, and/or acrylamides, such as N-benzylmethacrylamide, for example The monomers can also be used in mixtures with one another. Since monomer mixtures as well can be used to obtain a refractive index n_{d} of greater than 1.58 for the polymer blocks P(A), it is also possible for one or more components to possess, in the form of a homopolymer, a refractive index n_{d} of less than 1.58 at 25° C. Specific examples of such comonomers, without making any claim to completeness, are o-cresyl methacrylate, phenyl methacrylate, benzyl methacrylate or o-methoxyphenyl methacrylate. Additionally, however, the polymer blocks P(A) may also be constructed as copolymers such that they can consist to the extent of at least 75% of the above monomers of group A or of a mixture of these monomers, leading to a high softening temperature, but may also contain, at up to 25%, monomers of group B, leading to a lowering of the softening temperature of the polymer block P(A). In this context mention may be made, by way of example, of alkyl acrylates, which are defined in accordance with the structure B1 (see below) and the comments made in relation thereto.

Monomers of group B for the elastomer block P(B) are advantageously likewise chosen such that they contain C═C double bonds (especially vinyl groups and vinylic groups), with the proviso that the polymer block P(B) has a refractive index n_{d,B} of at least 1.43. As monomers of group B use is made advantageously of acrylate monomers. For this purpose it is possible in principle to use all of the acrylate compounds that are familiar to the skilled worker and are suitable for synthesizing polymers. It is preferred to choose those monomers which, alone or in combination with one or more further monomers, result in glass transition temperatures of less than +10° C. for the polymer block P(B). Correspondingly it is possible with preference to choose vinyl monomers.

For the preparation of the polymer blocks P(B) it is advantageous to use from 75% to 100% by weight of acrylic and/or methacrylic acid derivatives of the general structure

CH₂═CH(R¹)(COOR²) (B1)

where R¹═H or CH₃ and R²═H or linear, branched or cyclic, saturated or unsaturated hydrocarbon chains having 1 to 30, in particular having 4 to 18, carbon atoms and up to 25% by weight of monomers (B2) from the vinyl compounds group, these monomers B2 favorably containing functional groups.

The weight percentages above add up preferably to 100%, although the total may also amount to less than 100% by weight, if other (polymerizable) monomers are present.

Acrylic monomers of group B which are used very preferably in the sense of compound B1 as components for polymer blocks P(B) include acrylic and methacrylic esters with alkyl, alkenyl and/or alkynyl groups consisting of 4 to 18 carbon atoms. Specific examples of corresponding compounds, without wishing to be restricted by this recitation, include n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, branched isomers thereof, such as 2-ethylhexyl acrylate and isooctyl acrylate, and also cyclic monomers, such as cyclohexyl or norbornyl acrylate and isobornyl acrylate, for example.

In addition it is possible, optionally, to use vinyl monomers from the following groups as monomers B2 for polymer blocks P(B): vinyl esters, vinyl ethers, vinyl halides, vinylidene halides, and also vinyl compounds containing aromatic rings and heterocycles in a position. Here again mention may be made, by way of example, of selected monomers which can be used in accordance with the invention: vinyl acetate, vinylformamide, vinylpyridine, ethyl vinyl ether, 2-ethylhexyl vinyl ether, butyl vinyl ether, vinyl chloride, vinylidene chloride, acrylonitrile.

As particularly preferred examples of monomers containing vinyl groups, in the sense of B2, for the elastomer block P(B) suitability is additionally possessed by hydroxyethyl acrylate, hydroxypropyl acrylate, hydroxyethyl methacrylate, hydroxypropyl methacrylate, N-methylolacrylamide, acrylic acid, methacrylic acid, allyl alcohol, maleic anhydride, itaconic anhydride, itaconic acid, benzoin acrylate, acrylated benzophenone, acrylamide and glycidyl methacrylate, to name but a few.

All monomers which are capable of being employed may likewise be used in a halogenated form.

In one preferred embodiment of the PSAs having a refractive index of greater than 1.52 one or more of the polymer blocks contain one or more grafted-on side chains. The compounds in question may be compounds in which the side chains are obtained by graft-from processes (polymerizational attachment of a side chain, starting from an existing polymer backbone) or by graft-to processes (attachment of polymer chains to a polymer backbone via polymer-analogous reactions).

For preparing block copolymers with side chains it is possible in particular to use, as macromonomers from groups A and B, monomers functionalized in such a way as to allow a graft-from process for the grafting-on of side chains. Particular mention may be made here of acrylate and methacrylate monomers which carry halogen functionalization or functionalization provided by other functional groups which permit, for example, an ATRP (atom transfer radical polymerization) process. In this context mention may also be made of the possibility of introducing side chains into the polymer chains in a targeted way via the addition of macromonomers during the polymerization.

In one specific embodiment of this invention the polymer blocks P(B) have had incorporated into them one or more functional groups which permit radiation-chemical crosslinking of the polymer blocks, in particular by means of UV irradiation or bombardment with rapid electrons. With this objective, monomer units of group B which can be used include, in particular, acrylic esters containing an unsaturated hydrocarbon radical having 3 to 18 carbon atoms and containing at least one carbon-carbon double bond. Suitable with particular advantage for acrylates modified with double bonds are allyl acrylate and acrylated cinnamates. Besides acrylic monomers it is also possible with great advantage, as monomers for the polymer block P(B), to use vinyl compounds containing double bonds which are not reactive during the (free-radical) polymerization of the polymer block P(B). Particularly preferred examples of such comonomers are isoprene and/or butadiene, and also chloroprene.

In a further embodiment of the PSA, polymer blocks P(A) and/or P(B) are functionalized in such a way that a thermally initiated crosslinking can be carried out. As crosslinkers it is possible to choose favorably, among others: epoxides, aziridines, isocyanates, polycarbodiimides and metal chelates, to name but a few.

One preferred characteristic of the PSAs is that the molar mass Mₙ (number average) of at least one of the block copolymers or, in the case of two or more block copolymers, of all the block copolymers in particular, is between about 10 000 and about 600 000 g/mol, preferably between 30 000 and 400 000 g/mol, more preferably between 50 000 g/mol and 300 000 g/mol.

The fraction of the polymer blocks P(A) is advantageously between 5 and 40 percent by weight of the overall block copolymer, preferably between 7.5 and 35 percent by weight, more preferably between 10 and 30 percent by weight. The polydispersity D of the block copolymer is preferably less than 3, as given by the ratio of mass-average M_{w} to number-average Mₙ in the molar mass distribution. In the case of two or more block copolymers in the PSA of the invention the above details concerning the fractions and the polydispersity D apply advantageously for at least one of the block copolymers, but preferably for all of the block copolymers present.

In a further development of the invention the ratio V_{A/B}[V_{A/B}= l̅_{P(A)}/ l̅_{P(B)}] of the average chain lengths l̅_{P(A)} of the polymer blocks P(A) to the chain lengths l̅_{P(B)} of the polymer blocks P(B) is chosen such that the polymer blocks P(A) are present as a disperse phase (“domains”) in a continuous matrix of the polymer blocks P(B), in particular as spherical or distortedly spherical or cylindrical domains. This is preferably the case at a polymer blocks P(A) content of less than about 25% by weight. The formation of hexagonally packed cylindrical domains of the polymer blocks P(A) is likewise possible in the inventive sense.

In further advantageous embodiments of the PSA of the invention said PSA comprises a blend of
at least one diblock copolymer with at least one triblock copolymer, or
at least one diblock copolymer with at least one star-shaped block copolymer,
at least one triblock copolymer with at least one star-shaped block copolymer,
   preferably at least one of the aforementioned components, and advantageously all of the block copolymer components of the blend, constituting block copolymers in the sense of the definition of the main claim.

Particularly preferred embodiments of such blends are the following:

blends of the block copolymers comprising the sequence P(A)-P(B)-P(A), corresponding to the main claim, with diblock copolymers P(A)-P(B), where to prepare the corresponding polymer blocks P(A) and P(B) the same monomers as above can be used. It may further be of advantage to add polymers P′(A) and/or P′(B) to the PSA composed of the block copolymers, in particular of triblock copolymers (I), or to the PSA composed of a block copolymer/diblock copolymer blend, for the purpose of improving its properties.

Accordingly the invention further provides PSAs based on a blend of at least one block copolymer which has a refractive index n_{d} at 20° C. of greater than 1.52 with a diblock copolymer P(A)-P(B),
where the polymer blocks P(A) of the diblock copolymers independently of one another represent homopolymer or copolymer blocks of the monomers of group A, the polymer blocks P(A) of the diblock copolymers each having a softening temperature in the range from 0° C. to +175° C. and a refractive index n_{d,B} of greater than 1.58,
and where the polymer blocks P(B) of the diblock copolymers independently of one another represent homopolymer or copolymer blocks of the monomers of group B, the polymer blocks P(B) of the diblock copolymers each having a softening temperature in the range from −130° C. to +10° C. and a refractive index d_{d,A} Of greater than 1.43, and/or with polymers P(A) and/or P(B),
where the polymers P(A) represent homopolymers and/or copolymers of the monomers of group A, the polymers P(A) each having a softening temperature in the range from 0° C. to +175° C. and a refractive index n_{d,A} of greater than 1.58,
where the polymers P(B) represent homopolymers and/or copolymers of the monomers of group B, the polymers P(B) each having a softening temperature in the range from −130° C. to +10° C. and a refractive index n_{d,B′} of greater than 1.43,
and where the polymers P′(A) and P′(B) are preferably miscible with the polymer blocks P(A) and P(B), respectively, of the block copolymers corresponding to the main claim.

Where both polymers P′(A) and polymers P′(B) are admixed, they are advantageously chosen such that the polymers P′(A) and P′(B) are not homogeneously miscible with one another.

As monomers for the diblock copolymers P(A)-P(B), for the polymers P′(A) and P′(B), respectively, it is preferred to use the monomers of groups A and B already mentioned.

The diblock copolymers preferably have a molar mass Mₙ (number average) of between 5000 and 600 000 g/mol, more preferably between 15 000 and 400 000 g/mol, very preferably between 30 000 and 300 000 g/mol. They advantageously possess a polydispersity D=M_{w}/Mₙ of not more than 3. It is advantageous if the fraction of the polymer blocks P(A) in relation to the composition of the diblock copolymer is between 3% and 50% by weight, preferably between 5% and 35% by weight.

The figures relating to molecular weights (Mₙ and M_{w}), the polydispersity D and the molar mass distribution in the context of this specification relate to the determination by means of gel permeation chromatography (GPC). [Eluent THF (tetrahydrofuran) with 0.1% by volume trifluoroacetic acid; measuring temperature 25°; preliminary column: PSS-SDV, particle size 5 μm, porosity 10³ Å (0.1 μm), ID 8.0 mm×50 mm; separation: columns PSS-SDV, particle size 5 μm, porosity 10³ Å (0.1 μm) and 10⁵ Å (10 μm) and 10⁶ Å (100 μm) each with ID 8.0 mm×300 mm; sample concentration 4 g/l; flow rate 1.0 ml per minute; measurement against PMMA standards.]

Typical use concentration of diblock copolymers in the blend amount to up to 250 parts by weight per 100 parts by weight of block copolymers corresponding to the main claim comprising the unit P(A)-P(B)-P(A). The polymers P′(A) and P′(B), respectively, may be constructed as homopolymers and also as copolymers. They are advantageously chosen, in accordance with the comments made above, such that they are compatible with the polymer blocks P(A) and P(B), respectively, (of the block copolymer corresponding to the main claim). The chain length of the polymers P′(A) and P′(B), respectively, is preferably chosen such that it does not exceed that of the polymer block which is preferably miscible or associable with it, and advantageously is 10% lower, very advantageously 20% lower, than said length. The B block can advantageously also be chosen such that its length does not exceed half of the block length of the B block of the triblock copolymer.

In a further possible embodiment it is preferred to use (meth)acrylate PSAs.

Meth(acrylate) PSAs which are obtainable by free-radical polymerization are composed of at least 50% by weight of at least one acrylic monomer from the group of the compounds of the following general formula:

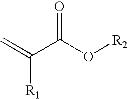

where R₁ is H or CH₃ and the radical R₂ is H or CH₃ or is chosen from the group of the branched or unbranched, saturated alkyl groups having 1-30 carbon atoms.

The monomers are preferably chosen such that the resulting polymers can be used, at room temperature or higher temperatures, as PSAs, in other words such that the resulting polymers possess pressure-sensitive adhesive properties.

In a further inventive embodiment the comonomer composition is chosen such that the PSAs can be employed as heat-activatable PSAs.

The meth(acrylate) PSAs have at least a refractive index n_{d}>1.43 at 220°.

The (meth)acrylate PSAs can be obtained preferably by polymerization of a monomer mixture which is composed of acrylic esters and/or methacrylic esters and/or the corresponding free acids, with the formula CH₂═CH(R₁)(COOR₂), where R₁ is H or CH₃ and R₂ is an alkyl chain having 1-20 C atoms or H.

The molar masses M_{w} of the polyacrylates employed are preferably M_{w}≧200 000 g/mol.

Use is made very preferably of acrylic or methacrylic monomers which consist of acrylic and methacrylic esters with alkyl groups of 4 to 14 C atoms, preferably comprising 4 to 9 C atoms. Specific examples, without wishing to be restricted by this recitation, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as isobutyl acrylate, 2-ethylhexyl acrylate, 2-ethylhexyl methacrylate, isooctyl acrylate and isoctyl methacrylate, for example. Further classes of compound which can be used are monofunctional acrylates and/or methacrylates of bridged cycloalkyl alcohols, consisting of at least 6 C atoms. The cycloalkyl alcohols may also be substituted, as for example by C-1-6 alkyl groups, halogen atoms or cyano groups. Specific examples are cyclohexyl methacrylates, isobornyl acrylate, isobornyl methacrylates, and 3,5-dimethyladamantyl acrylate.

One procedure uses monomers which carry polar groups such as carboxyl radicals, sulfonic and phosphonic acid, hydroxy radicals, lactam and lactone, N-substituted amide, N-substituted amine, carbamate radicals, epoxy radicals, thiol radicals, alkoxy radicals, cyano radicals, ether or the like.

Moderate basic monomers are, for example, N,N-dialkyl-substituted amides, such as N,N-dimethylacrylamide, N,N-dimethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxy)methacrylamide, N-methylolacrylamide, N-(ethoxy-methyl)acrylamide, N-isopropyl acrylamide, this recitation not being conclusive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glycerol methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, dimethylacrylic acid, this recitation not being conclusive.

A further very preferred procedure uses, as monomers, vinyl esters, vinyl ethers, vinyl halides, vinylidene halides, vinyl compounds with aromatic rings and heterocycles in α position. Here again, mention may be made, non-exclusively, of certain examples: vinyl acetate, vinylformamide, vinylpyridine, ethyl vinyl ether, vinyl chloride, vinylidene chloride, and acrylonitrile.

Use is made in particular, with particular preference, of comonomers which carry at least one aromatic, which possess a refractive index-increasing effect. Suitable components are aromatic vinyl compounds, such as styrene, for example, it being possible with preference for the aromatic nuclei to be composed of C₄ to C₁₈ building blocks and also to contain heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate and methacrylate, 2-naphthyl acrylate and methacrylate, and mixtures of those monomers, this recitation not being conclusive.

As a result of the increase in the aromatic fraction there is an increase in the refractive index of the PSA, and the scattering between glass and PSA by light is minimized.

Furthermore, in a further procedure, photoinitiators having a copolymerizable double bond are used. Suitable photoinitiators are Norrish-I and II photoinitiators. Examples are, for example, benzoin acrylate and an acrylated benzophenone from UCB (Ebecryl P 36®). In principle it is possible to copolymerize all of the photoinitiators that are known to the skilled worker that are able to crosslink the polymer via a free-radical mechanism under UV irradiation. An overview of possible photoinitiators that can be employed and that may be functionalized with a double bond is given in Fouassier: “Photoinitiation, Photopolymerization and Photocuring: Fundamentals and Applications”, Hanser-Verlag, Munich 1995. For supplementation, use is made of Carroy et al. in “Chemistry and Technology of UV and EB Formulation for Coatings, Inks and Paints”, Oldring (ed.), 1994, SITA, London.

For further development it is possible for resins to be admixed to the PSAs. Tackifier resins that can be used for addition are, without exception, all tackifier resins that are already known and are described in the literature, and possess no adverse effect on the transparency of the adhesive. As representatives, mention may be made of the pinene and indene resins and of rosins, their disproportionated, hydrogenated, polymerized, esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resulting adhesive in accordance with requirements. Generally speaking, it is possible to use any (soluble) resins that are compatible with the corresponding polyacrylate, and reference may be made in particular to all aliphatic, aromatic, alkylaromatic hydrocarbon resins, hydrocarbon resins based on pure monomers, hydrogenated hydrocarbon resins, functional hydrocarbon resins, and natural resins. Attention is drawn expressly to the depiction of the state of the art in the “Handbook of Pressure Sensitive Adhesive Technology” by Donatas Satas (van Nostrand, 1989). Here as well, for improving the transparency, it is preferred to use resins which are transparent and enjoy very good compatibility with the polymer. Hydrogenated or partially hydrogenated resins frequently have these qualities.

It is also possible, optionally, for plasticizers, further fillers (such as, e.g., fibers, carbon black, zinc oxide, chalk, solid or hollow glass beads, microbeads of other materials, silica, silicates), nucleators, electrically conductive materials, such as conjugated polymers, doped conjugated polymers, metal pigments, metal particles, metal salts, graphite, etc., expandants, compounding agents and/or aging inhibitors, in the form, for example, of primary and secondary antioxidants or in the form of light stabilizers, to have been added.

Additionally it is possible to admix crosslinkers and crosslinking promoters. Suitable crosslinkers for electron beam crosslinking and UV crosslinking are, for example, difunctional or polyfunctional acrylates, difunctional or polyfunctional isocyanates, (including those in blocked form) or difunctional or polyfunctional epoxides. It is also possible, furthermore, for heat-activatable crosslinkers to have been added, such as Lewis acid, metal chelates or polyfunctional isocyanates, for example.

For optional crosslinking with UV light it is possible to add UV-absorbing photoinitiators to the PSAs. Useful photoinitiators whose use is very good are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and others of the Norrish I or Norrish II type, may contain the following radicals: benzophenone-, acetophenone-, benzyl-, benzoin-, hydroxyalkylphenone-, phenyl cyclohexyl ketone-, anthraquinone-, trimethylbenzoylphosphine oxide-, methylthiophenyl morpholine ketone-, amino ketone-, azobenzoin-, thioxanthone-, hexarylbisimidazole-, triazine-, or fluorenone, it being possible for each of these radicals additionally to be substituted by one or more halogen atoms and/or one or more alkyloxy groups and/or one or more amino groups or hydroxy groups. A representative overview is given by Fouassier: “Photoinitiation, Photopolymerization and Photocuring, Fundamentals and Applications”, Hanser-Verlag, Munich, 1995. For supplementation it is possible to employ Carroy et al. in “Chemistry and Technology of UV and EB Formulation for Coatings, Inks and Paints”, Oldring (ed.), 1994, SITA, London.

The PSAs are advantageously chosen such that their refractive index is as close as possible to the refractive index of the glass on which the resulting PSA film is bonded.

In order to obtain a polymer glass transition temperature T_{g} which is preferred for PSAs, of ≦25° C., the monomers, in accordance with the statements above, are very preferably selected, and the quantitative composition of the monomer mixture advantageously chosen, such that, in accordance with the equation E1, in analogy to the Fox equation (cf. T. G. Fox, Bull. Am. Phys. Soc. 1 (1956) 123), the desired T_{g} value is obtained for the polymer.

$$\frac{1}{{T}_{g}} = {\sum }_{n}^{ } \frac{{w}_{n}}{{T}_{g , n}} \qquad ( E 1 )$$

In this equation, n represents the serial number of monomers employed, wₙ the mass fraction of the respective monomer n (% by weight), and T_{g,n} the respective glass transition temperature of the homopolymer of the respective monomers n, in K.

### Preparation of the PSAs

For the preparation of the poly(meth)acrylate PSAs it is advantageous to carry out conventional free-radical addition polymerizations. For the polymerizations which proceed by a free-radical mechanism it is preferred to use initiator systems which additionally comprise further free-radical initiators for the polymerization, more particularly thermally decomposing, radical-forming initiators of azo or peroxo type. In principle, however, all typical initiators familiar to the skilled worker for acrylates are suitable. The production of C-centered free radicals is described in Houben Weyl, Methoden der Organischen Chemie, vol. E 19a, pp. 60-147. These methods are preferentially employed in analogy.

Examples of free-radical sources are peroxides, hydroperoxides, and azo compounds; as a number of non-exclusive examples of typical free-radical initiators, mention may be made here of potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroktoate, benzpinacol. One very preferred version uses, as a free-radical initiator, 2,2′-azobis(2-methylbutyronitrile) (Vazo67®; DuPont), 1,1′-azobis(cyclohexanecarbonitrile) (Vazo 88® from DuPont) or azodiisobutyronitrile (AIBN).

The average molecular weights M_{w} of the PSAs formed in the course of the free-radical polymerization are very preferably chosen such that they are situated within a range from 200 000 to 4 000 000 g/mol; specifically for further use as an electrically conductive, pressure-sensitive hotmelt adhesive with resilience, PSAs are prepared having average molecular weights M_{w} of 400 000 to 1 400 000 g/mol. The statement of the average molecular weight is made with reference to the measurement by means of size exclusion chromatography (GPC; see above).

The polymerization may be carried out in bulk, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl acetate, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether), or mixtures thereof. The aqueous polymerization reactions may be admixed with a water-miscible or hydrophilic cosolvent in order to ensure that in the course of monomer conversion the reaction mixture is present in the form of a homogenous phase. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organosulfides, sulfoxides, sulfones, alcohol derivatives, hydroxyether derivatives, amino alcohols, ketones and the like, and also derivatives and mixtures thereof.

Depending on conversion rate and temperature, the polymerization time is between 2 and 72 hours. The higher the reaction temperature that can be chosen, in other words the higher the thermal stability of the reaction mixture, the lower the reaction time that can be chosen.

To initiate the polymerization it is essential, for the initiators which decompose thermally—that heat is introduced. For the initiators which decompose thermally the polymerization can be initiated by heating to 50 to 160° C., depending on initiator type.

For the preparation it may also be advantageous to polymerize the (meth)acrylate PSAs in bulk. Here it is suitable in particular to use the prepolymerization technique. The polymerization is initiated with UV light, but taken only to a low conversion rate of around 10%-30%. Subsequently this polymer syrup can be welded, for example, into films (in the simplest case ice cubes), and then polymerized through to a high conversion rate in water. These pellets can then be employed as acrylate hotmelt adhesives, the film materials used being with particular preference, for the melting operation, materials which are compatible with the polyacrylate. For this method of preparation as well it is possible to add the thermally conductive materials before or after the polymerization.

Another advantageous preparation process for the poly(meth)acrylate PSAs is anionic polymerization. In this case the reaction medium used comprises preferably inert solvents, such as aliphatic and cycloaliphatic hydrocarbons, for example, or else aromatic hydrocarbons.

The living polymer is in this case generally represented by the structure P_{L}(A)-Me where Me is a metal from group I , such as lithium, sodium or potassium, for example, and P_{L}(A) is a growing polymer formed from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium or octyllithium, this recitation making no claim to completeness. Furthermore, initiators based on samarium complexes are known for the polymerization of acrylates (Macromolecules, 1995, 28, 7886) and can be used here.

It is also possible, furthermore, to use difunctional initiators, such as 1,1,4,4-tetraphenyl-1,4-dilithiobutane or 1,1,4,4-tetraphenyl-1,4-dilithioisobutane, for example. Coinitiators may likewise be employed. Suitable coinitiators include lithium halides, alkali metal alkoxides or alkylaluminum compounds. In one very preferred version the ligands and coinitiators are chosen such that acrylate monomers, such as n-butyl acrylate and 2-ethylhexyl acrylate, for example, can be polymerized directly and do not have to be generated in the polymer by transesterification with the corresponding alcohol.

Also suitable for preparing poly(meth)acrylate PSAs with a narrow molecular weight distribution are controlled free-radical polymerization methods. For polymerization in that case it is preferred to use a control reagent of the following general formula:

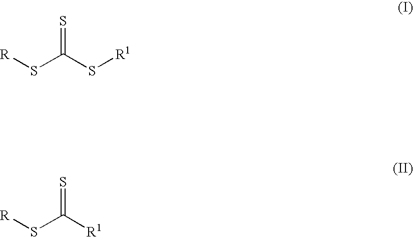

in which R and R¹, chosen independently of one another or alike, are
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkenyl radicals; C₃ to C₁₈ alkynyl radicals; C₁ to C₁₈ alkyl radicals substituted by at least one OH group or a halogen atom or a silyl ether;
C₂-C₁₈ heteroalkyl radicals having at least one O atom and/or an NR* group in the carbon chain, it being possible for R* to be any desired (especially organic) radical;
C₃-C₁₈ alkenyl radicals, C₃-C₁₈ alkynyl radicals, C₁-C₁₈ alkyl radicals substituted by at least one ester group, amine group, carbonate group, cyano group, isocyano group and/or epoxide group and/or by sulfur;
C₃-C₁₂ cycloalkyl radicals;
C₆-C₁₈ aryl or benzyl radicals;
hydrogen.

Control reagents of type (I) are preferably composed of the following further-restricted compounds:

halogen atoms here are preferably F, Cl, Br or I, more preferably Cl and Br. Outstandingly suitable as alkyl, alkenyl, and alkynyl radicals in the various substituents are both linear and branched chains.

Examples of alkyl radicals which contain 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl and octadecyl.

Examples of alkenyl radicals having 3 to 18 carbon atoms are propenyl, 2-butenyl, 3-butenyl, isobutenyl, n-2-4-pentadienyl, 3-methyl-2-butenyl, n-2-octenyl, n-2-dodecenyl, isododecenyl and oleyl.

Examples of alkynyl having 3 to 18 carbon atoms are propynyl, 2-butynyl, 3-butynyl, n-2-octynyl and n-2-octadecenyl.

Examples of hydroxyl-substituted alkyl radicals are hydroxypropyl, hydroxybutyl or hydroxyhexyl.

Examples of halogen-substituted alkyl radicals are dichlorobutyl, monobromobutyl or trichlorohexyl.

A suitable C₂-C₁₈ heteroalkyl radical having at least one O atom in the carbon chain is for example —CH₂—CH₂—O—CH₂—CH₃.

Examples of C₃-C₁₂ cycloalkyl radicals include cyclopropyl, cyclopentyl, cyclohexyl or trimethylcyclohexyl.

Examples of C₆-C₁₈ aryl radicals include phenyl, naphthyl, benzyl, 4-tert-butylbenzyl or further substituted phenyl, such as, for example, ethylphenyl, toluene, xylene, mesitylene, isopropylbenzene, dichlorobenzene or bromotoluene.

The lists above serve only as examples of the respective groups of compounds, and make no claim to completeness.

In addition it is also possible for compounds of the following types to be used as control reagents

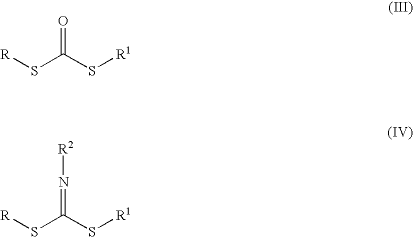

where R² likewise, independently of R and R¹, can be selected from the groups set out above for these radicals.

In the case of the conventional ‘RAFT process’, polymerization is usually taken only to low conversion rates (WO 98/01478 A1), in order to realize very narrow molecular weight distributions. As a result of the low conversion rates, however, these polymers cannot be used as PSAs, and more particularly not as pressure-sensitive hotmelt adhesives, since the high fraction of residual monomers adversely affects the adhesive properties; the residual monomers would contaminate the solvent recyclate in the concentration process, and the corresponding self-adhesive tapes would exhibit a very high level of outgassing. In order to circumvent this disadvantage of low conversion rates, the polymerization, in one particularly preferred procedure, is initiated repeatedly.

As a further controlled free-radical polymerization method it is possible to carry out nitroxide-controlled polymerizations. In an advantageous procedure, radical stabilization is effected using nitroxides of type (Va) or (Vb):

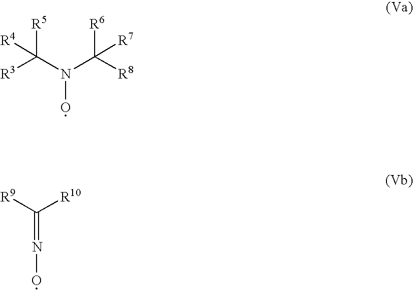

where R³, R⁴, R⁵, R⁶, R⁷, R⁸, R⁹, R¹⁰, independently of one another, denote the following compounds or atoms:
i) halides, such as chlorine, bromine or iodine,
ii) linear, branched, cyclic, and heterocyclic hydrocarbons having 1 to 20 carbon atoms, which may be saturated, unsaturated or aromatic;
iii) esters —COOR¹¹, alkoxides —OR¹² and/or phosphonates —PO(OR¹³)₂, where R¹¹, R¹² or R¹³ stand for radicals from group ii).

Compounds of the formulae (Va) or (Vb) may also be attached to polymer chains of any kind (primarily in the sense that at least one of the abovementioned radicals constitutes such a polymer chain) and can therefore be used to construct polyacrylate PSAs.

More preferably, controlled regulators are used for the polymerization of compounds of the type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trim ethyl-6-ethyl-1-piperidinyloxyl
N-tert-butyl-1-phenyl-2-methylpropyl nitroxide
N-tert-butyl-1-(2-naphthyl) 2-methylpropyl nitroxide
N-tert-butyl-1-diethylphosphono-2,2-dimethylpropyl nitroxide
N-tert-butyl-1-dibenzylphosphono-2,2-dimethylpropyl nitroxide
N-(1-phenyl-2-methyl propyl) 1-diethylphosphono-1-methylethyl nitroxide
di-t-butyl nitroxide
diphenyl nitroxide
t-butyl t-amyl nitroxide

A series of further polymerization methods according to which the PSAs may be prepared, in an alternative procedure, can be chosen from the prior art: U.S. Pat. No. 4,581,429 A discloses a controlled-growth radical polymerization process initiated using a compound of the formula R′R″N—O—Y in which Y is a free radical species which is able to polymerize unsaturated monomers. The reactions, however, generally have low conversion rates. A particular problem is the polymerization of acrylates, which proceeds only to very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process using very specific radical compounds such as, for example, phosphorus-containing nitroxides which are based on imidazolidine. WO 98/44008 A1 discloses specific nitroxyls based on morpholines, piperazinones, and piperazinediones. DE 199 49 352 A1 describes heterocyclic alkoxyamines as regulators in controlled-growth radical polymerizations. Corresponding further developments of the alkoxyamines and/or of the corresponding free nitroxides improve the efficiency for preparing polyacrylates.

As a further controlled polymerization method, it is possible advantageously to use atom transfer radical polymerization (ATRP) to synthesize the polyacrylate PSAs, with preferably monofunctional or difunctional secondary or tertiary halides being used as initiator and, to abstract the halide(s), complexes of Cu, Ni, Fe, Pd, Pt, RU, Os, Rh, Co, Ir, Ag or Au (EP 0 824 111 A1; EP 826 698 A1; EP 824 110 A1; EP 841 346 A1; EP 850 957 A1) being used. The different possibilities of ATRP are also described in the documents U.S. Pat. No. 5,945,491 A, U.S. Pat. No. 5,854,364 A, and U.S. Pat. No. 5,789,487 A.

### Carrier Materials

As carrier materials it is necessary to use polymer films which meet the stated requirements. In order to ensure sufficiently high levels of splinter protection, the film ought to have a tensile strength of greater than 150 MPa according to ASTM D 882. The haze value ought preferably to have a value of less than 3%, more preferably less than 1%, according to ASTM D 1003. The luminous transmittance by 550 nm is greater than 80%, more preferably greater than 85%. The thickness of the film is situated with particular preference between 12 and 100 μm, more preferably between 23 and 75 μm. Thus suitability is possessed, for example, by highly transparent polyester films. In particular, special highly transparent PET films (PET: polyethylene terephthalate) can be used. Thus suitability is possessed, for example, by films from Mitsubishi with the tradename Hostaphan™ or from Toray with the tradename Lumirror™. The highly transparent Lumirror™ T60 films in particular have proven outstandingly suitable for the inventive application of the PSA films.

Another very preferred species of the polyesters is represented by the polybutylene terephthalate films.

Besides polyester films it is also possible to use highly transparent PVC films (PVC: polyvinyl chloride). These films may include plasticizers to increase the flexibility.

It is also possible, furthermore, to use highly transparent PP film (PP: polypropylene). These films ought to have no crystalline regions that can disrupt the transparency. The PP films may be cast, monooriented or biaxially stretched.

For the purposes of the invention it is also possible, however, to use other transparent polyolefin films. Thus suitability is possessed as well, for example, by specially functionalized PE films (PE: polyethylene). As comonomers, as well as ethylene, it is also possible to use cyclohexene or norbornene derivatives, which suppress the tendency towards crystallization. Use may also be made, however, of a multiplicity of other olefinic comonomers besides ethylene, which disrupt the tendency towards crystallization by means of the steric arrangement.

For the purposes of the invention it is additionally possible to employ PC (polycarbonate) PMMA (polymethyl methacrylate), and PS (polystyrene) films. The films ought preferably to have a refractive index n_{d} of greater than 1.49.

Besides pure polystyrene it is also possible, for the purpose of reducing the tendency toward crystallization, to use other comonomers as well as styrene, such as butadiene, for example.

In addition it is also possible to employ polyether sulfone and polysulfone films as carrier materials. These can be obtained, for example, from BASF under the tradename Ultrason™ E and Ultrason™ S.

Furthermore, use may also be made of triacetylcellulose (TAC) films as carrier materials. Further cellulose-based raw materials are cellulose butyrate, cellulose propionate, and ethyl cellulose, which, in the form of comonomers or in the form of homopolymers, can likewise be employed as carrier films.

For the purposes of the invention it is also possible, with particular preference, to employ highly transparent TPU films (TPU: thermoplastic polyurethanes). These are available commercially, for example, from Elastogran GmbH.

Highly transparent polyamide films and copolyamide films can be used as well, furthermore.

It is also possible, furthermore, to use films based on polyvinyl alcohol and polyvinyl butyral.

Generally speaking, all other highly transparent films not mentioned so far can be used that have a refractive index n_{d} of greater than 1.49, a tensile strength of greater than 50 MPa according to ASTM D882, a haze value of less than 3%, very preferably of less than 2%, more preferably still of less than 1%, according to ASTM D1003, and a luminous transmittance at 550 nm of greater than 80%, according to ASTM D1003.

As well as single-layer films it is also possible to use multi-layer films, produced for example by coextrusion. For these purposes it is possible for the aforementioned polymer materials to be combined with one another.

Moreover, the films may have been treated. Thus, for example, vapor depositions may have been carried out, with zinc oxide, for example, or varnishes or adhesion promoters may have been applied.

In one preferred embodiment of the invention the film thickness is between 4 and 150 μm, more preferably between 12 and 100 μm.

### Product Constructions

The PSA tapes may be constructed in particular as follows:
a] single-layer adhesive films composed of a film carrier layer and a pressure-sensitive adhesive;
b] multilayer adhesive films consisting of a film carrier layer and the pressure-sensitive adhesive coated on both sides.

### a) Single-Layer Product Constructions

The PSAs may be coated onto films that are familiar for PSA tapes, such as polyesters, PET, PC, PP, BOPP (biaxially oriented polypropylene), PMMA, polyamide, polyimide, polyurethanes, PVC, for example.
Further suitable carrier materials for single-sided PSA tapes are described for example in U.S. Pat. No. 3,140,340, U.S. Pat. No. 3,648,348, U.S. Pat. No. 4,576,850, U.S. Pat. No. 4,588,258, U.S. Pat. No. 4,775,219, U.S. Pat. No. 4,801,193, U.S. Pat. No. 4,805,984, U.S. Pat. No. 4,895,428, U.S. Pat. No. 4,906,070, U.S. Pat. No. 4,938,563, U.S. Pat. No. 5,056,892, U.S. Pat. No. 5,138,488, U.S. Pat. No. 5,175,030 and U.S. Pat. No. 5,183,597. For the purposes of this specification, the use of transparent carriers is preferred.

### b) Multilayer Constructions

In the simplest version, the PSA is used to construct a double-sided PSA tape, the carrier material that can be used again being any of a very wide variety of films, such as polyesters, PET, PC, PMMA, PP, BOPP, polyamide, polyimide, polyurethanes or PVC, for example. To allow the PSA tape to be wound up, the double-sided PSA tapes are preferably lined with a release liner. Suitable release papers include glassine liners, HDPE liners or LDPE liners (HDPE: High Density Polyethylenes; LDPE: Low Density Polyethylenes), which in one preferred version possess a graduated release. In one very preferred version of the invention a film release liner is used. In one preferred procedure the film release liner ought to possess a graduation. Furthermore, the film release liner ought to possess an extremely smooth surface, so that the release liner does not effect structuring of the adhesive. This is preferably achieved through the use of PET films that are free from antiblocking agent, in combination of silicone systems which have been coated from solution.
As carrier film and stabilizing film it is possible in turn, furthermore, to use films which likewise possess a high refractive index n_{d} of greater than 1.43 at 20° C.

### Use

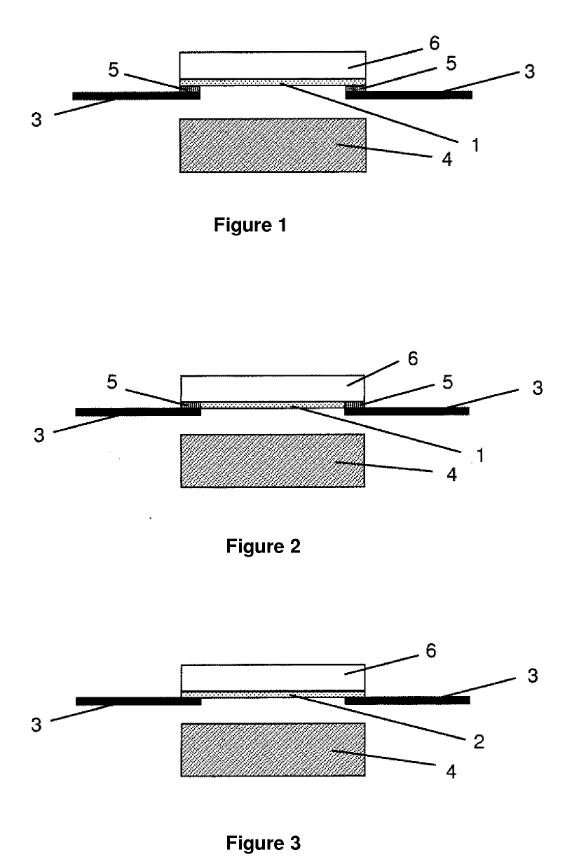

The use of the single-sided PSA tapes on the glass window may take place in accordance with a variety of mechanisms. Some embodiments of the use according to the invention are illustrated with reference to a number of exemplary figures (FIGS. 1 to 4), without any wish that the choice of embodiments in the invention should be restricted unnecessarily. The meanings of the reference numerals in the figures are as follows:
1 Inventive single-sided transparent PSA film
2 Inventive double-sided transparent PSA film
3 Housing (substrate on which the glass sheet is to be fixed)
4 Background (e.g., display; illumination)
5 Double-sided adhesive tape (especially diecut)
6 Glass window

In a first inventive embodiment of the invention the glass window is bonded with the transparent PSA film over its full area and then attached to the housing frame with an additional double-sided PSA tape. This embodiment is shown in FIG. 1.

FIG. 2 shows a further inventive embodiment; in this case, the glass window is not bonded over its full area with the transparent PSA film, but instead only in the region which remains optically transmitting. In the housing frame region, the glass window is attached with an additional double-sided PSA tape.

The use of the double-sided transparent PSA film on the glass window may take place preferably in accordance with the mechanism shown in FIG. 3. Here, the glass window is bonded over its full area with the transparent double-sided PSA film, and then attached in the frame/housing.

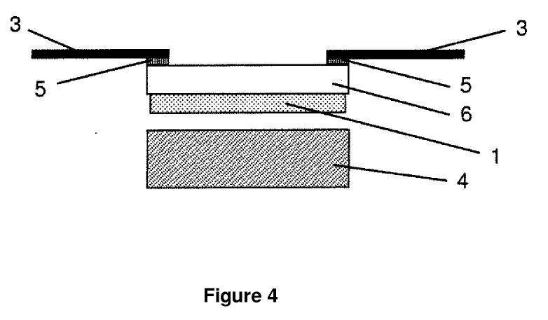

In a further advantageous embodiment of the invention the glass window is located internally in the housing; cf. FIG. 4. Here again, the glass sheet is attached to the housing frame using a double-sided adhesive tape (diecut), while the single-sided PSA film of the invention is provided on the side of the glass window facing away from the frame.

In order to achieve optimum full-area bonding of the anti-splinter adhesive film of the invention to the glass window, it is advantageous, in one preferred procedure, to heat the specimens after bonding, more particularly to store them at 40° C., for example, in order thus to optimize the flow behavior of the adhesive and to minimize air inclusions.

### Test Methods

### A. Refractive Index

The refractive index of the PSA was measured in a 25 μm film using the Optronic instrument from Krüss at 25° C. and with white light (A=550 nm±150 nm) in accordance with the Abbe principle. The instrument was stabilized in terms of temperature by operating it in conjunction with a thermostat from Lauda.

### B. Bond Strength

The peel strength (bond strength) was tested in accordance with PSTC-1. The PSA film is applied to a glass plate. A strip of the PSA film 2 cm wide (hereinafter: “adhesive strip”) is adhered by being rolled over back and forth three times using a 2 kg roller. The plate is clamped in and the adhesive strip is peeled off from its free end in a tensile testing machine under a peel angle of 180° and at a speed of 300 mm/min. The strength is reported in N/cm.

### C. Falling Ball Test

The PSA film is fixed without bubbles to a 1.1 mm glass sheet from Schott. The bond area is 4 cm×6 cm. Subsequently the assembly was stored for 48 h at 23° C. and 50% humidity. The assembly is then fixed in a holder so that the glass surface is aligned horizontally and the glass side is upward. 1 m above the glass surface, a steel ball of 63.7 g is fixed. The steel ball is then subjected to free fall, so that it falls onto the glass sheet.

A “pass” is scored in the test when less than 5% by weight of the glass splinters detach after the falling-ball test. The loss is determined by gravimetry (determination of the weight before and after the falling-ball test).

### D. Transmittance

The transmittance at 550 nm is determined in accordance with ASTM D1003. The system subjected to measurement was the assembly made up of optically transparent adhesive film and glass plate.

### E. Light Stability

The assembly of adhesive tape and glass plate, in a size of 4 cm×20 cm, is covered over half its area with a strip of card and then irradiated from a distance of 50 cm using Osram Ultra Vitalux 300 W lamps for 300 h. Following irradiation, the strip of card is removed and the discoloration is assessed visually.

A “pass” is scored in the test if there are not observable differences in coloration between the irradiated and masked regions (if, therefore, no discolorations occur that can be perceived by the naked eye).

### Production of Test Specimens

### Film:

The carrier film used was a 50 μm PET film of Lumirror™ T60 from Toray.

### Preparation of Nitroxides:

### (a) Preparation of the Difunctional Alkoxyamine (NIT 3):

Preparation took place in analogy to the experimental instructions from Journal of American Chemical Society, 1999, 121(16), 3904. Starting materials used were 1,4-divinylbenzene and nitroxide (NIT 4).

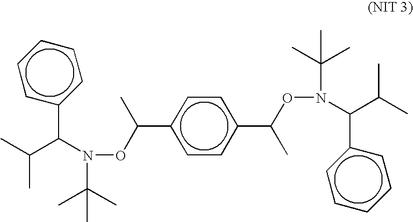

(b) Preparation of the nitroxide (NIT 4) (2,2,5-trimethyl-4-phenyl-3-azahexane 3-nitroxide):
Preparation took place in analogy to the experimental instructions from Journal of American Chemical Society, 1999, 121(16), 3904.

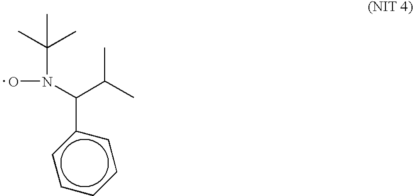

### Preparation of Polymer 1:

The polymerization was carried out using monomers which had been purified to remove stabilizers. A 2 L glass reactor conventional for free-radical polymerizations was charged with 32 g of acrylic acid, 168 g of n-butyl acrylate, 200 g of 2-ethylhexyl acrylate and 300 g of acetone/isopropanol (97:3). After nitrogen gas had been passed through the reactor for 45 minutes with stirring, the reactor was heated to 58° C. and 0.2 g of 2,2′-azobis(2-methylbutyronitrile) [Vazo67®; DuPont] was added. Thereafter the external heating bath was heated to 75° C. and the reaction was carried out constantly at this external temperature. After a reaction time of 1 h a further 0.2 g of Vazo67® was added. After 3 h and after 6 h, 150 g portions of acetone/isopropanol mixture were added for dilution. To reduce the residual initiators, 0.4 g portions of di(4-tert-butylcyclohexyl) peroxydicarbonate [Perkadox 16®; Akzo Nobel] were added after 8 h and after 10 h. After a reaction time of 22 h the reaction was discontinued, and the system was cooled to room temperature.

### Preparation of Polymer 2:

The polymerization was carried out using monomers which had been purified to remove stabilizers. A 2 L glass reactor conventional for free-radical polymerizations was charged with 20 g of acrylic acid, 40 g of methyl acrylate, 140 g of n-butyl acrylate, 200 g of 2-ethylhexyl acrylate and 300 g of acetone/isopropanol (97:3). After nitrogen gas had been passed through the reactor for 45 minutes with stirring, the reactor was heated to 58° C. and 0.2 g of Vazo67®; (DuPont) was added. Thereafter the external heating bath was heated to 75° C. and the reaction was carried out constantly at this external temperature. After a reaction time of 1 h a further 0.2 g of Vazo67® was added. After 3 h and after 6 h, 150 g portions of acetone/isopropanol mixture were added for dilution. To reduce the residual initiators, 0.4 g portions of Perkadox 16® (Akzo Nobel) were added after 8 h and after 10 h. After a reaction time of 22 h the reaction was discontinued, and the system was cooled to room temperature.

### Preparation of Polymer 3:

General procedure: a mixture of the alkoxyamine (NIT 3) and the nitroxide (NIT 4) (10 mol % to alkoxyamine (NIT 3)) is mixed with the monomer B [for the subsequent polymer block P(B)], and the mixture is degassed a number of times with cooling to −78° C., and then heated to 110° C. under pressure in a closed container. After a reaction time of 36 h the monomer A [for the subsequent polymer block P(A)] is added and polymerization is continued at this temperature for a further 24 hours.

In analogy to the general polymerization procedure, 0.739 g of the difunctional initiator (NIT 3), 0.0287 g of the free nitroxide (NIT 4), 128 g of isobornyl acrylate (distilled) and 192 g of 2-ethylhexyl acrylate (distilled) were used as monomers (B), and 180 g of o-methoxystyrene (distilled) were used as monomer (A). To isolate the polymer, the system was cooled to room temperature, and the block copolymer was dissolved in 750 ml of dichloromethane and then precipitated from 6.0 l of methanol (cooled to −78° C.) with vigorous stirring. The precipitate was filtered off over a chilled frit.

The product obtained was concentrated in a vacuum drying cabinet at 10 torr and 45° C. for 12 hours. The refractive index n_{d} was determined by test method A, and was 1.525.

### Blending of the Crosslinker Solution:

The solutions of polymers 1 and 2 resulting from the polymerization were each blended with 0.3% by weight of aluminum(III) acetylacetonate, with stirring, and diluted with acetone to a solids content of 30%.

### Production of PSA Film Specimen Example 1

A commercially available PET film 50 μm thick, of the Lumirror™ T60 type from Toray (meeting the requirements with regard to tensile strength, haze value, and transmittance according to claim 1), was coated with polymer 1 by means of a coating bar. Thereafter the solvent was slowly evaporated off. The adhesive film specimens were then dried at 120° C. for 10 minutes. The coatweight after drying was 100 g/m².

### Production of PSA Film Specimen Example 2:

A commercially available PET film 50 μm thick, of the Lumirror™ T60 type from Toray, was coated with polymer 2 by means of a coating bar. Thereafter the solvent was slowly evaporated off. The adhesive film specimens were then dried at 120° C. for 10 minutes. The coatweight after drying was 100 g/m².

### Production of PSA Film Specimen Example 3:

A PET film 50 μm thick, of the Lumirror™ T60 type from Toray, was coated with polymer 3 by means of a coating bar. Thereafter the solvent was slowly evaporated off. The adhesive film specimens were then dried at 120° C. for 10 minutes. The coatweight after drying was 100 g/m².

### Production of PSA Film Specimen Example 4:

A PET film 50 μm thick, of the Lumirror™ T60 type from Toray, was coated with polymer 1 by means of a coating bar. Thereafter the solvent was slowly evaporated off. The adhesive film specimens were then dried at 120° C. for 10 minutes. The coatweight after drying was 50 g/m². Then bubble-free lining was carried out using a PET release liner from Siliconature (transparent PET film, 50 μm thick, single-sidedly siliconized with a silicone system coated from solution, with a roughness of less than 0.1 Ra). The adhesive film specimen was then turned and the uncoated PET side of the carrier was then coated in turn with polymer 1 by means of a coating bar. Thereafter the solvent was evaporated off, slowly. The adhesive film specimens were then dried at 120° C. for 10 minutes. The coatweight after drying was 50 g/m². Bubble-free lining was then carried out on this side as well using a PET release liner from Siliconature (transparent PET film, 50 μm thick, single-sidedly siliconized with a silicone system coated from solution with a roughness of less than 0.1 Ra).

### Production of PSA Film Specimen Example 5:

A PET film 50 μm thick, of the Lumirror™ T60 type from Toray, was coated with polymer 2 by means of a coating bar. Thereafter the solvent was slowly evaporated off. The adhesive film specimens were then dried at 120° C. for 10 minutes. The coatweight after drying was 50 g/m². Then bubble-free lining was carried out using a PET release liner from Siliconature (transparent PET film, 50 μm thick, single-sidedly siliconized with a silicone system coated from solution, with a roughness of less than 0.1 Ra). The adhesive film specimen was then turned and the uncoated PET side of the carrier was then coated in turn with polymer 2 by means of a coating bar. Thereafter the solvent was evaporated off, slowly. The adhesive film specimens were then dried at 120° C. for 10 minutes. The coatweight after drying was 50 g/m². Bubble-free lining was then carried out on this side as well using a PET release liner from Siliconature (transparent PET film, 50 μm thick, single-sidedly siliconized with a silicone system coated from solution with a roughness of less than 0.1 Ra).

### Bonding:

The PSA film specimens (examples 1 to 5) were applied without bubbles, using a rubber roller, to the 1.1 mm thick glass sheet D 263 T (borosilicate glass with refractive index n_{d} of 1.5231) from Schott. For the double-sided PSA films, the release liner was removed on one side before the bonding was performed. The applied pressure was 40 N/cm² for 10 seconds.

### Results

### Results

Following the production of the test specimens, first the bond strengths on glass were measured for all of examples 1 to 5. The values are collected in table 1.

TABLE 1

| Example | BS Glass (Test B) |
|---|---|
| 1 | 7.8 |
| 2 | 8.9 |
| 3 | 6.4 |
| 4 | 8.2 |
| 5 | 9.6 |

BS: instantaneous bond strength in N/cm

The values measured indicate that the PSA films used exhibit high instantaneous bond strengths on glass and therefore develop effective adhesion.

Furthermore, all of examples 1 to 5 were investigated by the falling-ball test, test C. The results are set out in table 2 below.

TABLE 2

| | Falling-ball test |
|---|---|
| Example | (Test C) |
| 1 | <2% by weight* |
| 2 | <2% by weight* |
| 3 | <2% by weight* |
| 4 | <2% by weight* |
| 5 | <2% by weight* |

*based on the weight of the glass

From the results it is apparent that through the specific construction of the PSA films (structure of the carrier film and of the adhesive), the profile of properties has been optimized to provide very effective anti-splinter protection. The test was passed clearly by all the examples (1 to 5). In no case did more than 2% by weight of the glass splinters detach.

Furthermore, the transmittance test, test D, was carried out with all of examples 1 to 5. This test was used to ascertain whether there is sufficiently high transmittance available when the anti-splinter adhesive tape is bonded to the glass window. The values measured for the assembly are set out in table 3.

TABLE 3

| | Transmittance |
|---|---|
| Example | (Test D) |
| 1 | 78% |
| 2 | 78% |
| 3 | 74% |
| 4 | 76% |
| 5 | 76% |

From table 3 it can be seen that all of examples 1-5 exhibit a transmittance of greater than 70% and therefore have a high level of optical clarity.

For use in exterior applications, moreover, the light stability test, test E, was carried out. Here the PSA film specimens of examples 1-5 are each exposed for 300 h to intensive incandescent lamps which simulate sunlight exposure. The results are assembled in table 5.

TABLE 5

| | Light stability |
|---|---|
| Example | (Test E) |
| 1 | Pass |
| 2 | Pass |
| 3 | Pass |
| 4 | Pass |
| 5 | Pass |

The results demonstrate that the high ageing stabilities typical of polyacrylates are realized. Accordingly the PSA films of the invention can also be used for long-term applications. There is no discoloration that might distort the depiction of the image or alter its color.

Besides the test methods, examples 1 to 5 were subjected to a performance test, and the assembly made up of glass sheet and PSA films of examples 1-5 was bonded in PC housings. All of the examples showed high suitability for practical application.

1. A pressure-sensitive adhesive film comprising at least one carrier film and at least one layer of a pressure-sensitive adhesive, wherein the carrier film possesses:
a tensile strength of at least 50 MPa, measured according to ASTM D882,
a haze value of not more than 3%, measured according to ASTM D1003, and
a transmittance for light with a wavelength of 550 nm of at least 80%, measured according to ASTM D1003,
and in that the pressure-sensitive adhesive film possesses
a transmittance of at least 70%, measured according to ASTM D1003.

2. The pressure-sensitive adhesive film of claim 1, wherein the haze value of the carrier film is not more than 2%, measured according to ASTM D1003.

3. The pressure-sensitive adhesive film of claim 1, wherein the carrier film possesses a refractive index of at least 1.48.

4. The pressure-sensitive adhesive film of claim 1, wherein the pressure-sensitive adhesive is based on polyacrylates and/or polymethacrylates.

5. The pressure-sensitive adhesive film of claim 1, wherein the pressure-sensitive adhesive has a refractive index of 1.43 (25° C.; λ=550 nm±150 nm).

6. The pressure-sensitive adhesive film of claim 1, wherein the pressure-sensitive adhesive is based on acrylate block copolymers.

7. The pressure-sensitive adhesive film of claim 1, wherein the pressure-sensitive adhesive is based on silicone rubbers.

8. The pressure-sensitive adhesive film of claim 1, wherein the pressure-sensitive adhesive has a refractive index of 1.52 (25° C.; λ=550 nm±150 nm).

9. An assembly composed of a pressure-sensitive adhesive film of claim 1 and a glass sheet on the side of the layer of pressure-sensitive adhesive that is facing away from the carrier film.

10. A method of protecting a glass sheet from splintering, said method comprising adhering to said glass sheet a single-sided or double-sided pressure-sensitive adhesive film of claim 1.
